(19) United States
(12) Patent Application Publication
(10) Pub. No.: US 2025/0249783 A1
(43) Pub. Date: Aug. 7, 2025

(54) REAL-TIME ARTIFICIAL INTELLIGENCE AND MACHINE LEARNING TO MANAGE ELECTRIC VEHICLE CHARGING, DISPATCH OPERATIONS AND YARD MANAGEMENT FOR FLEETS

(71) Applicant: MOEV, Inc., Los Angeles, CA (US)

(72) Inventors: Vandana MANGAL, Los Angeles, CA (US); Chi Cheng CHU, Aliso Viejo, CA (US); Yijing JIANG, Los Angeles, CA (US); Weiheng YUAN, Yorba Linda, CA (US); Aasim WANI, Torrance, CA (US)

(21) Appl. No.: 18/886,999

(22) Filed: Sep. 16, 2024

Related U.S. Application Data
(60) Provisional application No. 63/538,457, filed on Sep. 14, 2023.

(51) Int. Cl. B60L 53/68; G06Q 50/40

(52) U.S. Cl. CPC B60L 53/68; G06Q 50/40; B60L 2200/18

(57) ABSTRACT

A system and method that takes as input streamed and real-time data from the electric vehicle, from the charging station, from vehicle routes and scheduling systems, weather, traffic, and terrain from appropriate data streams, and uses Artificial Intelligence software using Machine Learning Technology on the Internet Cloud to manage electric vehicle charging, dispatch operations, and yard management for electric fleets is provided which combines data-driven decision making, deep learning, optimization, and statistical methods.

### CROSS-REFERENCE TO RELATED APPLICATION

This application claims benefit and priority to U.S. Provisional Patent Application No. 63/538,457, filed Sep. 14, 2023, the disclosures of which are incorporated by reference herein in their entireties.

### FIELD OF THE INVENTION

The present invention relates to the field of electric vehicle (EV) management, and more particularly, to smart charging, yard management and operations management of charging of electric vehicle fleets.

### BACKGROUND OF THE INVENTION

Fleet management, particularly in the public transit sector, involves the organization of vehicles into blocks, each representing a collection of trips along specific routes. Traditional block configurations can become suboptimal due to factors such as route changes, detours, accidents, and the introduction of new vehicles into the fleet, especially in the context of transitioning to electric buses.

Unlike traditional internal combustion engine vehicles, BEVs lack an internal combustion engine, resulting in fundamentally different servicing, repair, and maintenance needs. The maintenance requirements for BEVs are notably distinct due to their unique servicing and operational characteristics.

Current charging stations often lack robust monitoring and control interfaces, which can hinder efficient charging management. In situations where charger communication protocols fail, accessing charging data becomes challenging. This invention addresses this issue by utilizing alternative data sources, specifically telematics data from EVs.

In conventional transit bus fleet yards, ample space has traditionally been allocated for the maneuvering and parking of buses across various locations within the yard. However, the introduction of electric vehicle chargers, encompassing both overhead pantograph chargers and ground-mounted variants, has imposed substantial constraints on bus mobility within these facilities. Moreover, this incorporation has led to a notable reduction in the overall available yard space. Consequently, as fleets make the transition towards battery electric buses, the necessity for advanced yard management systems has become evident.

Asset management refers to the process of installing, operating, maintaining in a cost-effective manner. Most commonly used in finance, the term is used in reference to individuals or firms that manage assets on behalf of individuals or other entities. Every infrastructure owner, individuals or companies needs to keep track of its assets. Asset management is about processes to optimize cost of assets (CAPEX +OPEX) to support the business. With the advent of Digital Solution and Internet of Things (IoT), asset managers often rely on dedicated software platforms to support their processes. In the context of electric bus and truck fleets, the assets are the vehicles the main cost of which is the battery whose life dictates the total cost of ownership, and managing, monitoring and extending the life of the battery helps keep the asset cost down for the fleet operators.

### SUMMARY OF THE INVENTION

The system and method takes as input streamed and real-time data from the electric vehicle, from the charging station, from vehicle routes and scheduling systems, weather, traffic, and terrain from appropriate data streams, and uses Artificial Intelligence software using Machine Learning Technology on the Internet Cloud to manage electric vehicle charging, dispatch operations, and yard management for electric fleets. The system combines data-driven decision making, deep learning, optimization, and statistical methods.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 illustrates system architecture in accordance with an embodiment of the present invention.

FIG. 2 illustrates system locating vehicle at charger in accordance with an embodiment of present invention.

FIG. 3 shows system application in trips, mapping to blocks, mapping to runs in accordance with an embodiment of present invention.

FIG. 4 shows the en-route charging scheduling and reservation for a transit agency with two en-route chargers in accordance with an embodiment of present invention.

FIG. 5 is a graphical representation showing removal of phantom charging with single port charger in accordance with an embodiment of present invention.

FIG. 6 is a graphical representation showing removal of phantom charging with dual port charger in accordance with an embodiment of present invention.

FIG. 7 illustrates dispatch optimization prototype with multiple spatial constraints in accordance with an embodiment of present invention.

FIG. 8 illustrates dispatch optimization prototype in dense parking environment in accordance with an embodiment of present invention.

FIG. 9 illustrates EV Battery overheated warning provided in real time, and used in prediction in accordance with an embodiment of present invention.

FIG. 10 illustrates battery life prediction model used for asset management in accordance with an embodiment of present invention.

FIG. 11 illustrates system architecture for telematics based charging management in accordance with an embodiment of the present invention.

### BRIEF DESCRIPTION OF THE INVENTION

### Technology: Time Synchronized Correlation via Sensor Measurements of the CAN Bus of a Vehicle and Sensor Data From an Electric Vehicle Charging Station

The system and method takes as input measurements of sensor data from the can bus of an electric vehicle (the can bus data is provided through the telematics as shown in the Figure below), and correlates it with the charging session data from the charging station connected to the electric vehicle as well as a smart meter connected in series on the electric circuit of the charging station, and correlates information that is available in a time-stamped manner between these three data sources, to be able to extract new knowledge that is useful for smart charging, parking and yard management, dispatch management and reliable charging applications.

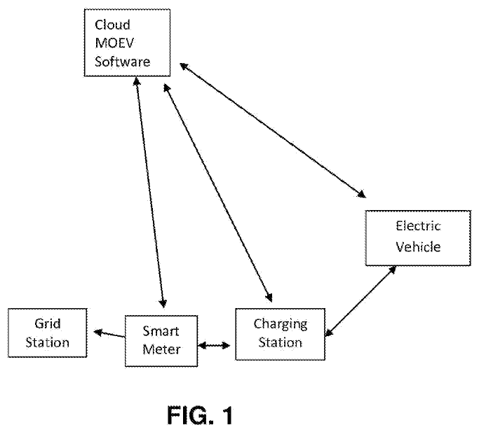

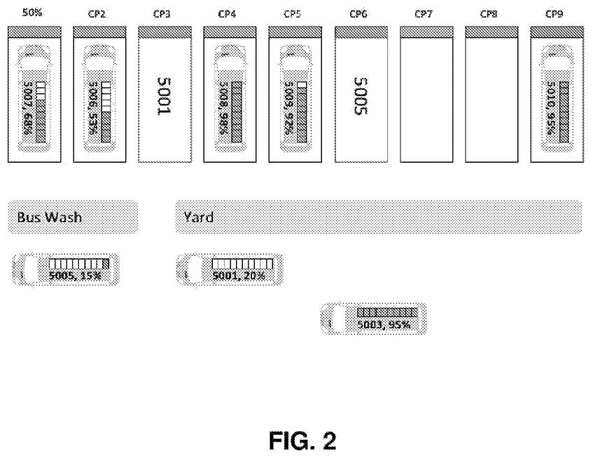

The system and method finds its application in different areas. The first of such applications is determining which parking spot a vehicle is parked in. Given that the charging station is located at a fixed parking spot, and this parking spot is known, as for the illustration, the data obtained from the charging session and the data obtained from the telematics provided via can bus, is correlated via carefully mapped timestamps, in combination with machine learning approach, to be able to ascertain the location the vehicle is parked in, and which charging station the vehicle is plugged into. This enables the electric fleet dispatch operator once the vehicle is charged to the adequate level, to be able to pull the vehicle out and move it to the dispatchable location from the charging location. FIG. 1 illustrates system and method architecture in accordance with an embodiment of the present invention.

A second application for this technology is the determination of charging failure root cause. The failure to charge a vehicle over an extended period of time, can be due to several issues. The cause might be the electric vehicle such as the electric vehicle might have to be down for maintenance, or the electric vehicle software has some made some error, or the software of the EV has not been upgraded to the last version, or that the EV does not have the standards fully implemented or that it is using an older version of the standard compared to the charging station. Therefore the root cause might be the vehicle but there can be many more reasons. Reading, parsing and analyzing the codes from the electric vehicle, such as the OBD2 codes that are put out by the electric vehicle by way of the telematics system and method, our system and method can determine whether the errors are coming from the electric vehicle and what type of error it is and what action needs to be taken.

Alternatively, the fault might be originating from the charging station. The charging station might be non-functional, it might be generating incorrect codes transmitted to the vehicle, or it is not fully compatible with known and published standards, or perhaps it needs repair, or any other reason, and by looking at the codes generated by the electric vehicle charging station using a protocol such as open charge point protocol or OCPP, our system and method can determine whether the problem lies with the charging station and what type of problem that is. Also, when we have a sufficient amount of time series of data over a continuous period of time, we will be able to isolate the type of the error using deep learning algorithms such as Long short term memory and Hidden Markov Models. The cause of the error can also be identified by using statistical distance functions as Dynamic Time Warping or Edit Distance with real penalty.

A third source of faults might be the electric infrastructure that powers the charging station and EV. Typically, a smart meter is installed in series ahead of the charging station but after the transformer, and data from the smart meter is parsed, analyzed and evaluated for any faults that may lie in the electric infrastructure. This analysis reveals information about the condition of the circuit.

The above three independent analyses use AI based machine learning for coming up with the inferencing. In addition, a more sophisticated approach uses integrating the time stamped information from all three sources called an Integrated Approach. In this Integrated Approach, our system and method performs analysis using machine learning on time-stamped data from the following three sources—(i) smart meter (ii) charging station, and, (iii) electric vehicle, and this analysis uses a variety of inferring schemes so as to determine whether the fault lies in the electric vehicle or the charging station or the electric power infrastructure at the site. In certain instances the time stamps are not exactly synchronized and in those situations, machine learning over historical data is used to correlate across the three data sources.

Example of time stamped data:
Telematics data including timestamp, current, voltage, power, energy, State Of Charge (“SOC”), speed, GPS, etc. from the bus side.
Charging station data including timestamp, current, voltage, power, energy, SOC, etc. from the charger side.
Meter data including timestamp, power, energy, etc. from meter reading.
Weather data including timestamp, temperature, humidity, windspeed, etc.

Example of correlation of time stamped data:
Time of charging stoppage as detected from vehicle: 04:23a.m.
Time of charging stoppage as detected from charger: 04:43a.m.
State of charge of vehicle: 40%

The above situation would indicate the bus stopped taking in the power even though the charger was attempting to send the power to the bus ten minutes past the time when the bus stopped receiving the time, even though the bus state of charging was below the lowest level needed for serving the next day's routes.

An example of machine learning result is that the AI approach detects this situation and provides a conclusion that there is a fault within the bus for refusing to accept the power. The above information in combination with other data such as temperature, current, voltage, and other technical variables enables us to pinpoint not only that the bus is having an issue with charging but what is the specific pattern of such an issue thereby predicting such issues in the future using our machine learning technology.

The above approach is utilizable by our Machine Learning algorithms to perform not only real-time assessment using ML, but also predictive failure of an EV during operation by using correlation between the different sources. An example is prediction of power loss to an EV from a charger—due to power electronics and temperature and battery voltage difference.

### Technology—Dynamically Customizing Bus-Block Assignment Algorithms to Enable Electric Buses to Service the Needs of the Transit Dispatch Operations

The present invention provides dynamically customizing bus-block assignment algorithm to enable electric buses to service that needs of the transit dispatch operation.

There's a unique challenge that's been spotted when it comes to the limitations of Electric Buses (EVs). These buses, with their limited range and longer charging times, don't quite fit into the traditional ‘block’ structure of transit routes that have been designed for their diesel counterparts.

For instance, if an EV bus has a range of 240 miles, it doesn't fully utilize a short 120-mile block, and it can't handle a 340-mile long block. If it takes on a short block, only about 50% of its capacity is used, but it can't be assigned another short block because it needs to keep a 15% charge to make it back to the yard.

A major concern is that transit agencies often struggle with customizing these block assignments for EVs. This is where a potential solution comes in: an innovative algorithm. This algorithm would take in all block schedules, submitted in the General Transit Feed Specification (GTFS) format, and then churn out a customized set of block combinations that maximize the utility of the EVs.

For example, an EV could be assigned half a long block and half a short block, thereby creating two new custom blocks. The algorithm would also factor in how hard it would be for the bus to commute between two blocks. If it's too far, then the blocks won't be combined as it would cause unnecessary energy usage.

This approach could also mean that transit agencies won't have to negotiate with software companies to redesign the blocks. The algorithm would handle it. Plus, using machine learning models from MOEV.ai, more insights are gathered about the exact behavior of a specific EV bus on its assigned blocks. This could provide a more accurate range estimate, leading to smoother operations.

In summary, this solution would maintain the original block structure for traditional buses, but offer custom ones for EVs, ensuring they are used to their full potential. It's a balance of innovation and practicality for better efficiency in transit systems.

### Technology: Refining Transit Bus Operations to Enable Them to Service the Needs of Dispatch Operations and Operate at Multiple Levels of Hierarchy

The system and method of the present invention can be used for refining transit bus operations to enable them to service the needs of dispatch operations and operate at multiple levels of hierarchy.

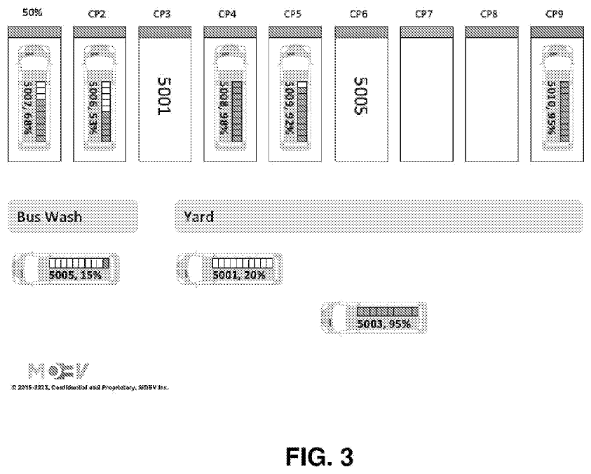

In public transit operations, there are distinct hierarchical levels to organize daily operations as shown in the figure below. Normally, ‘Trip’ refers to one single trip in the route, ‘Block’ is served by the bus, ‘Run’ is served by the driver. FIG. 3 shows system and method application in trips, mapping to blocks, mapping to runs in accordance with an embodiment of present invention.

“Block” is the combination of trips of one route. All the trips in one route will usually be pieced into several separate blocks. The purpose of designing blocks in traditional public transit is to: 1. cover all the service and minimize the out of service time; 2. minimize the layover time (the break time between two trips); 3. make sure drivers have enough rest time during the layover period; 4. avoid frequently switching the bus between routes, which will confuse the passengers. Thus usually, one bus will serve a complete block on one route every day.

“Run” is the smaller piece of the block. “Run” always comes with a “Paddle”, which is the work schedule of the driver. Some of the blocks will serve the route the whole day. While the driver's working time is more flexible and unstable than the blocks, which means the driver might not be able to finish the block during his working time. Drivers' working time can vary from serving the whole day, serving half day, and serving several hours, etc. To better manage the assignment of drivers and blocks, transit agencies will take the following steps: 1. Transit agencies will split the long blocks into several pieces, which is called run, and assign the runs to the available drivers. For example, in most cases, the blocks will be divided into morning runs and afternoons. Then the driver available in the morning can serve the morning run, the driver available in the afternoon can serve the afternoon run. 2. Transit agencies use paddles to provide the detailed work schedule to the driver who is assigned to this paddle. In some cases, two or more drivers might serve the different runs under the same long block. Also one driver might serve two or more short blocks. The design of the runs and paddles is to maximize the efficiency of drivers serving on the blocks. Usually, one driver will be assigned to one paddle every day.

With the integration of new electric buses into transit agencies, accommodating these electric vehicles (EVs) within existing operational structures presents challenges due to their unique mileage limitations. In response, various transit agencies have adopted distinct approaches to adapt their daily operations.

Some agencies adhere to conventional practices, seeking suitable blocks for the EVs and addressing variations within this established framework. Conversely, others opt for innovative block combinations, with some even directly employing paddles, to maximize EV utilization. However, determining how to allocate electric buses across different block combinations poses a substantial challenge for dispatchers, given the inherent variability in traffic, road conditions, and passenger demands associated with each block.

Our system and method offers indispensable support to dispatchers by leveraging AI and machine learning models. It assists in identifying the optimal combination of buses and schedules, thereby enabling the most efficient utilization of electric buses and enhancing overall operational efficiency.

Also, our system and method keeps monitoring the performance of the BEBs while they are on the road. This feature is not affected by whether the bus is assigned to one or more blocks. As long as the schedule of the bus has been fed into the system and method, then the performance of the bus in the future is predictable by using the system and method. If a bus is on a new block and its battery goes down really fast, the system and method will send an alert to the dispatcher. This tells them that the bus needs attention and might need to be swapped with another bus to finish the route.

### Technology: Efficient En-route Electric Vehicle Charging Management

The system and method of the present invention can also be used for efficient en-route vehicle charging management in accordance with an embodiment of the present invention.

In the realm of electric bus fleets, the importance of En-route chargers escalates as routes extend, and buses grapple with maintaining an adequate state of charge throughout their designated journeys. En-route chargers, strategically positioned along these routes, cater specifically to electric buses and other commercial electric vehicles. Without these en-route chargers, transit agencies are constrained to assign electric vehicles to shorter routes near the bus yard, necessitating frequent recharging.

Our strategy encompasses the utilization of the Open Charge Point Protocol (OCPP) to oversee bus charging at these en-route charging stations. To ensure the effective management of the charging process, we rely on real-time data pertaining to bus locations and their pre-assigned daily routes. This invaluable information is accessible through sources like GTFS-rt or real-time output from a Computer-aided Dispatch/Automatic Vehicle Locator (CAD/AVL) system and method, and GTFS-static. Our objective is minimization of waiting times for each bus during the charging process.

While it's theoretically possible for a transit agency to autonomously handle this endeavor, our approach presents a distinct advantage. We possess the capability to optimize the charging schedule by factoring in predetermined bus routes for all the partner transit agencies. This optimization empowers us to make informed decisions about whether to commence charging immediately or defer it to a later juncture along the route.

Since these are shared en-route charging stations, a scenario may arise where two or more buses from adjacent routes converge at the same charger concurrently. In such instances, our dispatching algorithm comes into play, establishing a priority system and method that determines which bus takes precedence, while the other patiently waits. Alternatively, if one of the buses already possesses adequate charge to reach the subsequent charger, it can circumvent the queue, proceeding with charging without delay and charge later in its block.

Our proprietary dispatch algorithms are equipped to predict the time required for a specific bus to traverse a charging station queue. This computation encompasses the cumulative time needed to charge each bus in the queue to a desirable state of charge (SOC). Importantly, this is a dynamic dispatch algorithm, as buses may deviate from their assigned schedules due to detours or other disruptions to their designated routes.

The above problem statement could be expressed in terms of an resource allocation optimization problem, as follows:
Resource=Charger Time
Agent=Bus

The Objective is to: 1. minimize the overall time to departure, i.e. time to full charge for the bus+time through queue to get to the charge; 2. Minimize the delay experienced by sum of all buses when proceeding with the block.

### Constraints

All buses which have left the charging bay must have enough charge to maintain a certain desired charge (hard constraint): Full charge; Charge enough to make it to the next overhead/En-route charger; Enough charge to get the complete block/back to the bus yard.

All buses at the charging station must depart early enough to maintain their routing schedule (soft constraint). If the bus ends up being late there should be a negative constraint associated on a per minute basis.

The charger would also have peak load, ideally we might want to reduce the maximum charge (soft constraint). dependent on the overall lateness of buses.

If the remaining miles in charge is greater than the distance to the next stop, and time in the queue is long, provide for them a route to the alternate charger in the partner network.

### Failsafe Planning

Overtime as the bus battery degrades the charger will take much longer to full charge.

Plan if the charger is failing and if the charger had failed and buses were expecting to charge them, we might have to provide warnings or provide a route to an alternative on route charger.

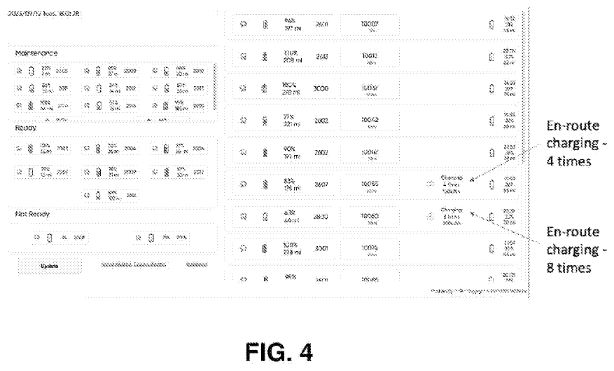

FIG. 4 shows the en-route charging scheduling and reservation for a transit agency with two en-route chargers in accordance with an embodiment of present invention.

### Technology: Filtering out Phantom Charging Using Machine Learning Software in Electric Vehicles

In another embodiment of the present invention, the system and method provides Filtering out Phantom Charging using Machine Learning Software in Electric Vehicles

In the realm of electric vehicles, an observed phenomenon pertains to the continued flow of electricity when chargers are connected to the vehicle, even after the vehicle's battery attains a 100% state of charge. This phenomenon, known as “Phantom charging,” sustains various auxiliary circuits within the vehicle, including but not limited to LED lights and status circuits. While the impact of such Phantom power on smaller electric vehicles, such as passenger cars, remains negligible, it assumes greater significance in the context of medium and heavy-duty vehicles, such as buses and trucks. Our system and method, deployed at transit electric bus fleet sites, has measured this load to be as high as 5 KW.

For instance, when a bus achieves a full charge by 10:00p.m. and is scheduled to depart at 8:00a.m. the following day, it experiences an approximate loss of 50 kilowatt hours of energy. This results in unnecessary heating of both the bus and the charger, in addition to significant financial wastage for the fleet operator. Assuming an electricity cost of $25 per unit, this translates to an additional expenditure of $0.25 per hour, amounting to $2.50 per day per bus, or an approximate annual loss of $900 per bus for a fleet consisting of 100 vehicles. Cumulatively, for a fleet of this size, the annual financial impact totals approximately $90,000, with the added burden of unnecessary load imposed on the grid operator during nighttime charging operations.

To address this issue, our innovative solution employs machine learning technology in conjunction with real-time data obtained from both the bus and the charger. This enables us to detect the specific conditions necessitating disconnection. Detection hinges on a combination of the distinct charging curves, unique to each bus and charger, learned through our machine learning-based pattern recognition during numerous charging sessions. Additionally, we incorporate our proprietary model to enhance the precision of our results. Furthermore, we utilize data pertaining to current, voltage, temperature, and other relevant variables within both the charger and the bus to achieve accurate predictions regarding the optimal timing for ceasing charging and initiating disconnection, executed virtually within the charger.

Our system and method has been successfully deployed at two transit bus fleet operator sites, and the ensuing results are comprehensively presented in the two accompanying charts.

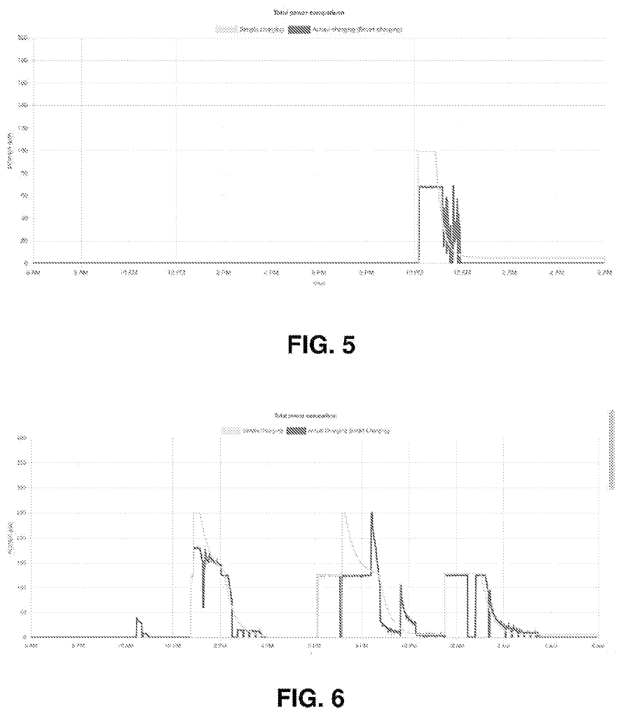

FIG. 5 is a graphical representation showing removal of phantom charging with single port charger in accordance with an embodiment of present invention.

FIG. 6 is a graphical representation showing removal of phantom charging with dual port charger in accordance with an embodiment of present invention.

### Technology: Automatic Yard Management for Battery Electric Bus Fleet Yards Fleet

In another embodiment of the present invention, the system and method provides automatic yard management for Battery electric bus fleet yards fleet.

In conventional transit bus fleet yards, ample space has traditionally been allocated for the maneuvering and parking of buses across various locations within the yard. However, the introduction of electric vehicle chargers, encompassing both overhead pantograph chargers and ground-mounted variants, has imposed substantial constraints on bus mobility within these facilities. Moreover, this incorporation has led to a notable reduction in the overall available yard space. Consequently, as fleets make the transition towards battery electric buses, the necessity for advanced yard management system and methods has become evident.

Our proprietary yard management system and method operates by ingesting several key parameters: the arrival and departure times of each battery electric bus, the energy requirements of up to eight battery electric buses, technical specifications and battery capacities of each bus, the attributes and positions of charging stations, real-time GPS and telematics data from the buses, and subsequently determines the optimal sequence for bus operations, parking arrangements, charging procedures, and departure sequences from designated parking spots.

The system and method harnesses the power of artificial intelligence, machine learning algorithms, historical data, and predictive analytics to assess and ascertain the precise parking locations for each bus. This evaluation considers factors such as the mileage capabilities of individual buses, enabling an informed decision-making process.

The accompanying illustrations exemplify a prototype deployment of our system and method at two transit bus fleet yard, showcasing its practical implementation in real-world scenarios.

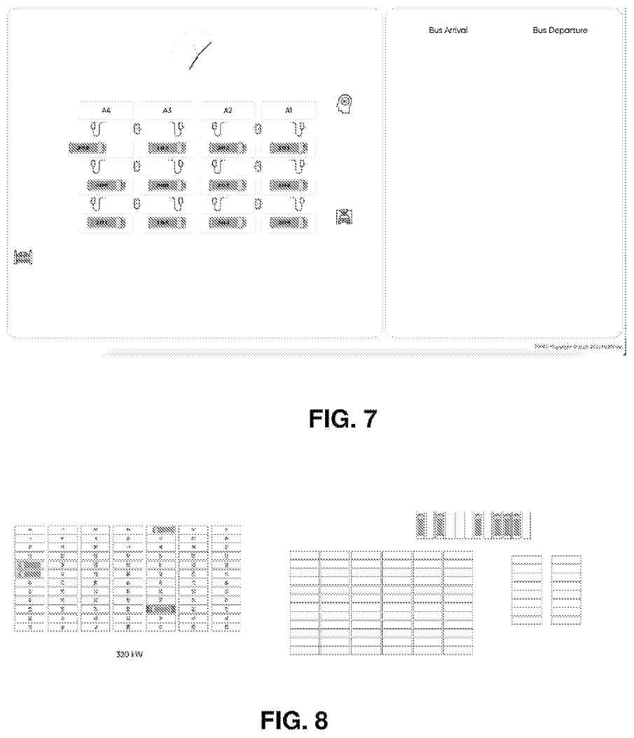

FIG. 7 illustrates dispatch optimization prototype with multiple spatial constraints in accordance with an embodiment of present invention.

FIG. 8 illustrates dispatch optimization prototype in dense parking environment in accordance with an embodiment of present invention.

### Technology: Using AI and Machine Learning for Maintenance and Service Prediction in Electric Vehicles

In another embodiment of the present invention the system and method is provided for Using AI and machine learning for Maintenance and Service Prediction in Electric Vehicles.

Battery electric vehicles (BEVs) differ fundamentally from internal combustion engine (ICE) vehicles in terms of propulsion and maintenance. The present invention introduces a novel technology that leverages historical and real-time telematic data collected from BEVs to predict and diagnose maintenance needs, with a primary focus on the battery and associated charging components. This technology supports the maintenance requirements of electric vehicle fleets, offering significant advantages in terms of efficiency and cost savings.

Our innovative technology harnesses historical and real-time data collected from BEVs through telematic system and methods, with data intervals ranging from 0.001 seconds to 5 minutes, depending on the predictive objective. This data encompasses a comprehensive array of parameters, including:
Vehicle speed, acceleration, and braking behavior.
Vehicle weight, cargo, and payload information.
Traffic conditions and driving routes.
Terrain and environmental factors (e.g., temperature and humidity).
Driver behavior characteristics.
Technical variables associated with battery charging and discharging.
Charging profiles and charger types (e.g., AC, DC).
Block and run data for the vehicle's daily operations.

The above data are captured through the telematics of the vehicle.

Our predictive maintenance system and method employs a machine learning algorithm that utilizes the above data to assess, in real-time, the probability of maintenance events. Historical maintenance data, combined with these variables, enables the system and method to forecast future maintenance patterns and determine specific probabilities of failure for each failure mode.

Furthermore, the system and method categorizes maintenance needs into those that impact vehicle operation and those that do not. For instance, if the system and method predicts a 30% reduction in a battery's power output under specific conditions, it recognizes the need for maintenance but distinguishes it as non-hazardous concerning vehicle operation.

A cloud-based software component continuously predicts maintenance requirements for each vehicle in a fleet over the next 24 hours, as the vehicles return to the yard. This enables the maintenance department to anticipate the number of buses requiring maintenance and the nature of required maintenance. These predictions extend over daily, weekly, and monthly planning horizons, facilitating the efficient management of transit bus fleets.

The technology is not limited to transit bus fleets but extends to medium and heavy-duty electric fleets, including delivery trucks, garbage trucks, tractor-trailers, and more. The system and method's predictive capabilities are designed to accommodate complex events, such as distinguishing charging patterns between specific chargers and vehicles, aiding in precise maintenance planning at the individual charger and vehicle level.

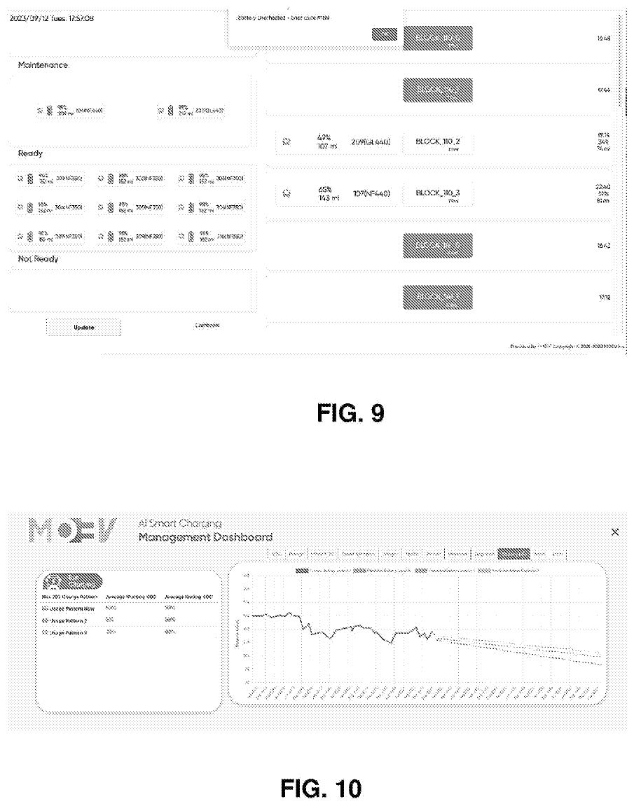

Our predictive maintenance system and method for battery electric vehicles represents a groundbreaking innovation in the field of electric vehicle fleet management. By leveraging historical and real-time data, machine learning, and cloud-based predictive software, this technology revolutionizes maintenance planning, enhances operational efficiency, and reduces costs for electric vehicle fleets across various applications. The figure below shows the screenshot of a prototype implementation. FIG. 9 illustrates EV Battery overheated warning provided in real time, and used in prediction in accordance with an embodiment of present invention.

### Technology: Dynamic Block Optimization for Electric Vehicle Fleet Management

In another embodiment of the present invention a dynamic block optimization for electric vehicle fleet management is provided.

The present invention pertains to a novel system and method using AI and machine learning and method for the dynamic optimization of vehicle blocks within a fleet, with a particular emphasis on electric vehicles (EVs). It involves real-time adjustments to the composition and scheduling of blocks based on evolving factors, such as route modifications, detours, accidents, and the incorporation of new vehicles into the fleet. This inventive approach aims to maximize the utilization of EVs and enhance overall operational efficiency.

The invention relates to the field of fleet management, with a specific focus on optimizing the allocation of vehicles to blocks, particularly in the context of electric vehicle (EV) fleets. It addresses the need for flexible and dynamic block configuration to accommodate evolving operational requirements.

The inventive system and method and method offer a dynamic approach to block optimization, with two key components:
i. Route-Based Block Modification: The system and method assesses the routes served by the fleet and, when new buses are introduced or operational changes occur, dynamically using machine learning on fleet operational data modifies the blocks down to a level of detail that optimally aligns with customer needs. This ensures efficient utilization of resources and minimizes operational disruptions.
ii. Real-Time Data Integration: The system and method continuously integrates real-time data, including detours, accidents, and other relevant information, to dynamically adjust block configurations using machine learning on fleet operational data. It allows for the reassignment of buses to better respond to changing conditions, ensuring an optimal balance between service coverage and operational efficiency.

Consider an agency with 100 buses transitioning to battery electric buses (BEBs). Initially, 10 BEBs are introduced and assigned to 10 blocks. However, optimization reveals that this assignment is suboptimal. The system and method uses machine learning and automatically reassigns these BEBs to 9 blocks, effectively dividing one block into two, and adjusts the bus schedules accordingly. This dynamic allocation optimizes resource utilization.

The system and method's adaptability extends to a future-oriented approach where buses are assigned to runs rather than blocks. This approach aims to maximize the utilization of BEBs, enabling them to serve multiple portions of different blocks. Additionally, the system and method adapts to changing state-of-charge (SOC) criteria, ensuring optimal utilization of battery capacity.

The dynamic block optimization system and method and method presented herein represent a significant advancement in the field of fleet management, particularly for electric vehicle fleets. By embracing real-time data and route-based adjustments, it enhances operational efficiency, minimizes disruptions, and maximizes the utilization of electric vehicles. This invention is applicable not only to transit bus fleets but also to other medium and heavy-duty electric vehicle fleets in various industries.

### Technology: AI-Powered Asset Management System and Method for Electric Transit Buses

In another embodiment of the present invention, an AI-powered asset management system and method for electric transit buses is provided in accordance with an embodiment of the present invention. Transit asset management (TAM) is a way of running a business that focuses on using funding for public transportation based on how well things are working. The goal is to make sure that the transportation system and method stays in good shape and works properly. The present invention pertains to an advanced asset management system and method tailored for the evolving landscape of the transit bus industry, particularly the transition from internal combustion engine (ICE) buses to zero-emission electric buses. Employing artificial intelligence (AI) and machine learning, this system and method predicts and refines the lifecycle of buses, batteries, chargers, and stationary assets. It leverages a multitude of real-time and historical data sources to optimize asset management strategies and enable precise replacement planning. The invention relates to asset management in the transit bus industry, specifically concerning the management, repair, servicing, and replacement of buses, batteries, chargers, and stationary assets. It addresses the need for adapting asset management approaches and strategies as the industry transitions to electric buses.

The proposed system and method employs AI-based machine learning techniques to predict the life cycles of buses and their associated components, including batteries and chargers. It refines asset management strategies by considering a wide range of variables:
Bus-specific and battery-specific data, utilization patterns, driver behavior, and performance trends over time.
External factors such as weather conditions and traffic that influence asset wear and tear.
Yard operations and charging parameters, including power levels, frequency of charging, and charging profiles.
Internal battery variables, encompassing current flow, charging/discharging rates, temperature, humidity, and repair/service history.

FIG. 10 illustrates battery life prediction model used for asset management in accordance with an embodiment of present invention.

The system and method continuously monitors and collects data from these variables, storing it in a cloud-based software platform. Predictions are dynamically adjusted as new data becomes available. A combination of real-time data and a self-learning model, regularly updated using the collected data, ensures accurate asset lifecycle predictions. This approach allows for rapid system and method deployment, even in scenarios where minimal initial data is available.

The system and method extends its capabilities to manage stationary assets such as charging stations and transformers supplying power to chargers. Key variables considered for lifecycle assessment and degradation predictions include:
Power profiles of charging stations.
Charging session data, including session frequency and power profiles.
Communication and interactions between buses and chargers.
Power control functions, including vehicle-to-grid (V2G) systems.
Local temperature, humidity, voltage, frequency, power outages, and service history.

The AI-powered asset management system and method presented herein represents a significant advancement in the transit bus industry. By harnessing AI and machine learning, it enables precise prediction, optimization, and refinement of asset life cycles, benefiting transit agencies, operators, and stakeholders alike. This invention enhances the efficiency and cost-effectiveness of asset management, ensuring the smooth transition to electric buses and the reliable operation of charging infrastructure.

### Technology: Charging Management System and Method for Electric Vehicles Utilizing Access Control CAN-Bus Telematics Electric Vehicle

In another embodiment of the present invention, Charging Management System and method for Electric Vehicles Utilizing Access Control CAN-bus Telematics Electric Vehicle is provided. The present invention addresses the challenges associated with electric vehicle (EV) charging, particularly when charger communication protocols fail or are unavailable. In such scenarios, the system and method leverages alternative data streams, specifically telematics data from the electric vehicle, to gather critical charging information. Through AI and machine learning, the system and method predicts the EV's charging needs and optimizes charger control, considering factors such as maximum battery capacity, demand charges, and time-of-use pricing. This innovative approach enhances charger control, reduces costs, and extends battery life while optimizing fleet operations through real-time scheduling and dispatch management.

The invention pertains to electric vehicle (EV) charging management system and methods, focusing on scenarios where charger communication protocols are unreliable or unavailable. It introduces a novel approach that utilizes telematics data from EVs to gather charging information, employs AI and machine learning to predict charging needs, optimizes charger control, and enhances fleet operations through real-time scheduling and dispatch management.

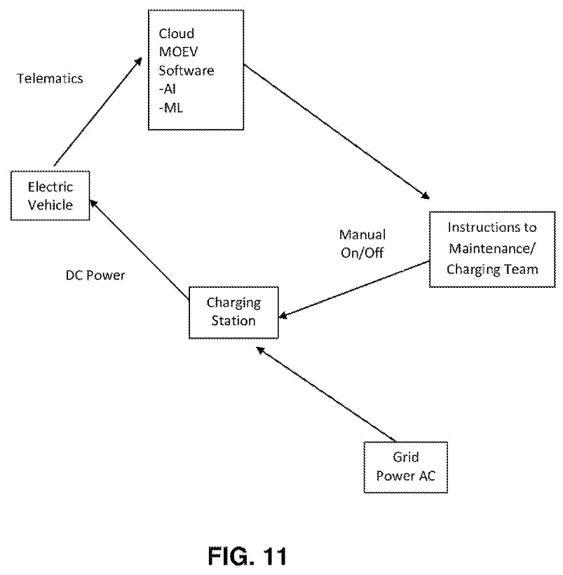

The proposed system and method relies on telematics data streams from EVs, providing real-time information about charging activities, including start times, duration, and charging profiles. AI and machine learning algorithms process this data to predict the required charging for each EV. The Charging profile, though not directly controllable, is considered in the prediction process as shown in FIG. 11.

Key input data includes maximum battery capacity, demand charges, and time-of-use pricing. These parameters are used to optimize the electric bill for site hosts. The system and method aggregates individual charging profiles into a gross charging profile, encompassing all connected EVs sharing a meter. This optimization yields a schedule for plug-in and plug-out times for each charger. Phantom charging, where chargers continue to draw power unnecessarily, is mitigated by recommending a plug-out time to fleet operators. Battery life is also maximized while minimizing electric costs. The system and method communicates the plug-in and plug-out schedule to dispatch operators via a user interface (dashboard) or application program interface. This empowers operators to efficiently manage EV charging to meet the operational demands of the fleet, enhancing overall dispatch optimization.

The charging management system and method presented herein revolutionizes EV charging control in scenarios where charger communication is unreliable. By leveraging telematics data and employing AI-driven predictions, it optimizes charger utilization, reduces costs, extends battery life, and enhances fleet operations through real-time scheduling and dispatch management. This invention offers a comprehensive solution to the challenges of managing electric vehicle charging in a dynamic and cost-effective manner.

1. A method for managing electric vehicles comprising the steps of,
(i) taking input measurements of sensor data from the can bus of an electric vehicle; and
(ii) correlating said input measurements of sensor data with charging session data from a charging station connected to said electric vehicle and a smart meter connected in series on the electric circuit of the charging station;
wherein said correlating is performed in a time-stamped manner.

2. A method for determining which parking spot an electric vehicle is parked in, comprising the steps of:
(i) determining known charging station parking spots;
(ii) obtaining first data from one or more charging sessions;
(iii) obtaining second data from telematics provided via a can bus;
wherein said first and second data are timestamped;
(iv) applying machine learning to obtain a location of a parked charging electric vehicle and determine which charging station said parked charging electric vehicle is plugged into; and
(v) conveying said location and charging station to a dispatch operator.

3. A method for determining the error causing a charging failure, comprising the steps of:
(i) reading OBD2 codes from an electric vehicle's telematics system
(ii) parsing said OBD2 codes; and
(iii) analyzing the codes from the electric vehicle to determine whether the charging failure is due to the electric vehicle and to determine the type of error
such as the OBD2 codes that are put out by the electric vehicle by way of the telematics system our system and method can determine whether the errors are coming from the electric vehicle and what type of error it is and what action needs to be taken.

4. A method for determining the error causing a charging failure, comprising the steps of:
using an open charge point protocol to obtain codes generated by an electric vehicle charging station;
collecting said codes over a predetermined time period to establish a time series of data;
analysing said time series of data using machine learning tools selected from one or more of Long Short Term Memory and Hidden Markov Models to determine the type of error causing the charging failure; and optionally
using statistical distance functions as Dynamic Time Warping or Edit Distance with real penalty to determine the cause of said error causing the charging failure.

5. A method for determining the error causing a charging failure, comprising the steps of:
collecting data from a smart meter installed ahead of a charging station but after a transformer;
parsing the data;
analysing the data for faults in electrical infrastructure to determine condition of a circuit.

6. (canceled)

7. (canceled)

8. (canceled)

9. (canceled)

10. The method of claim 3 wherein the analyses use AI based machine learning to determine inferences.

11. The method of claim 4 wherein the analyses use AI based machine learning to determine inferences.

12. The method of claim 5 wherein the analyses use AI based machine learning to determine inferences.

13. The method of claim 3 wherein the analyses use machine learning on time-stamped data from the following three data sources—(i) smart meter (ii) charging station, and, (iii) electric vehicle, and inferring schemes to determine whether the fault lies in the electric vehicle or the charging station or the electric power infrastructure at the charging site.

14. The method of claim 4 wherein the analyses use machine learning on time-stamped data from the following three data sources—(i) smart meter (ii) charging station, and, (iii) electric vehicle, and inferring schemes to determine whether the fault lies in the electric vehicle or the charging station or the electric power infrastructure at the charging site.

15. The method of claim 5 wherein the analyses use machine learning on time-stamped data from the following three data sources—(i) smart meter (ii) charging station, and, (iii) electric vehicle, and inferring schemes to determine whether the fault lies in the electric vehicle or the charging station or the electric power infrastructure at the charging site.

16. The method of claim 13 wherein, when the time stamped data is not synchronized, machine learning is used with historical data to correlate across the three data sources.

17. The method of claim 14 wherein, when the time stamped data is not synchronized, machine learning is used with historical data to correlate across the three data sources.

18. The method of claim 15 wherein, when the time stamped data is not synchronized, machine learning is used with historical data to correlate across the three data sources.

19. The method of claim 1 wherein time stamped data comprises one or more of:
one or more telematics data from the bus side selected from the group consisting of timestamp, current, voltage, power, energy, State Of Charge (“SOC”), speed, and GPS,
one or more charging station data from the charger side selected from the group consisting of timestamp, current, voltage, power, energy, SOC, etc.,
one or more meter data from meter reading selected from the group consisting of timestamp, power, and energy,
one or more weather data selected from the group consisting of timestamp, temperature, humidity, windspeed,
one or more time of charging stoppage as detected from vehicle,
one or more time of charging stoppage as detected from charger, and
one or more state of charge of vehicle.

20. The method of claim 2 wherein time stamped data comprises one or more of:
one or more telematics data from the bus side selected from the group consisting of timestamp, current, voltage, power, energy, State Of Charge (“SOC”), speed, and GPS,
one or more charging station data from the charger side selected from the group consisting of timestamp, current, voltage, power, energy, SOC, etc.,
one or more meter data from meter reading selected from the group consisting of timestamp, power, and energy,
one or more weather data selected from the group consisting of timestamp, temperature, humidity, windspeed,
one or more time of charging stoppage as detected from vehicle,
one or more time of charging stoppage as detected from charger, and
one or more state of charge of vehicle.

21. The method of claim 3 wherein time stamped data comprises one or more of:
one or more telematics data from the bus side selected from the group consisting of timestamp, current, voltage, power, energy, State Of Charge (“SOC”), speed, and GPS,
one or more charging station data from the charger side selected from the group consisting of timestamp, current, voltage, power, energy, SOC, etc.,
one or more meter data from meter reading selected from the group consisting of timestamp, power, and energy,
one or more weather data selected from the group consisting of timestamp, temperature, humidity, windspeed,
one or more time of charging stoppage as detected from vehicle,
one or more time of charging stoppage as detected from charger, and
one or more state of charge of vehicle.

22. The method of claim 4 wherein time stamped data comprises one or more of:
one or more telematics data from the bus side selected from the group consisting of timestamp, current, voltage, power, energy, State Of Charge (“SOC”), speed, and GPS,
one or more charging station data from the charger side selected from the group consisting of timestamp, current, voltage, power, energy, SOC, etc.,
one or more meter data from meter reading selected from the group consisting of timestamp, power, and energy,
one or more weather data selected from the group consisting of timestamp, temperature, humidity, windspeed,
one or more time of charging stoppage as detected from vehicle,
one or more time of charging stoppage as detected from charger, and
one or more state of charge of vehicle.

23. The method of claim 5 wherein time stamped data comprises one or more of:
one or more telematics data from the bus side selected from the group consisting of timestamp, current, voltage, power, energy, State Of Charge (“SOC”), speed, and GPS,
one or more charging station data from the charger side selected from the group consisting of timestamp, current, voltage, power, energy, SOC, etc.,
one or more meter data from meter reading selected from the group consisting of timestamp, power, and energy,
one or more weather data selected from the group consisting of timestamp, temperature, humidity, windspeed,
one or more time of charging stoppage as detected from vehicle,
one or more time of charging stoppage as detected from charger, and
one or more state of charge of vehicle.
